(19) United States
(12) Patent Application Publication
(10) Pub. No.: US 2010/0070937 A1
(43) Pub. Date: Mar. 18, 2010

(54) CIRCUIT VERIFICATION APPARATUS, CIRCUIT VERIFICATION METHOD, AND RECORDING MEDIUM

(75) Inventor: Takeo Nishide, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/482,569

(22) Filed: Jun. 11, 2009

(30) Foreign Application Priority Data
Sep. 12, 2008 (JP) 2008-234896

(51) Int. Cl. G06F 17/50

(52) U.S. Cl. 716/4

(57) ABSTRACT

A circuit verification apparatus includes a code coverage measurement point extracting unit which reads a device-under-test circuit description written in a hardware description language and metrics information including information about multiple measurement objects, extracts multiple measurement points for code coverage measurement from the device-under-test circuit description, and generates a database including only predetermined measurement points among the extracted multiple measurement points. The circuit verification apparatus also includes an assertion converting unit configured to convert each of the predetermined measurement points to a corresponding assertion description and a code coverage result decompressing unit configured to receive the database and an assertion result obtained by performing measurement based on the assertion description and generate a code coverage result.

### CROSS-REFERENCE TO RELATED APPLICATION

This application is based upon and claims the benefit of priority from the prior Japanese Patent Application No. 2008-234896 filed in Japan on Sep. 12, 2008; the entire contents of which are incorporated herein by reference.

### BACKGROUND OF THE INVENTION

1. Field of the Invention

The present invention relates to a circuit verification apparatus, circuit verification method and recording medium and, in particular, to a circuit verification apparatus, circuit verification method and recording medium for measuring code coverage.

2. Description of Related Art

As the circuit scales of LSIs have been increased and the turnaround time has been reduced in LSI designing in these years, the problem of quality degradation has arisen because of errors left undetected by verification of LSI designs.

Today, code coverage is widely used as a typical measure of the testing exhaustiveness, that is, the accuracy of verification of logic circuits. Code coverage is a measure quantitatively representing the degree to which a circuit description has been tested in a simulation by determining whether each code in the circuit description has been executed or not.

For example, an LSI design verification apparatus has been proposed that is capable of measuring code coverage (see for example Japanese Patent No. 3848157).

Code coverage has been measured by inserting monitor statements called “probes” for code coverage measurement in a circuit description that is a duplication of an actual device under test (DUT). Then, the code coverage is measured on the basis of information collected by the probes.

However, as the number of probes in a circuit description increases, overhead in a simulation occurs and the time required for logic verification increases. The time required for logic verification further increases with increased scale and complexity of circuits.

Therefore, emulation is used as means for addressing the increased circuit scale and complexity. In the emulation, a DUT is mapped to a processor or a programmable circuit such as an FPGA and logics are verified, thereby the time required for logic verification can be significantly reduced.

However, mapping a DUT in which probes for code coverage measurement are inserted to a programmable circuit is impractical because the size of the circuit increases. That is, there is a problem that code coverage cannot be measured in emulation at present. Accordingly, the testing exhaustiveness cannot be known, which leads to device quality degradation.

It may be conceived to use assertions written in an assertion language, which is a description language for LSI function verification, to perform logic verification. For example, an apparatus has been proposed that automatically generates an assertion according to an input assertion schema (see for example U.S. Patent Application Publication No. 2008/0066030).

The apparatus automatically generates assertions for toggle measurement for input/output signals and uses the generated assertions to perform code coverage measurement in a simulation.

However, no disclosure is made of assertions except assertions for toggle measurement in the proposal. Furthermore, the apparatus has a problem that it takes much time to measure code coverage since the apparatus does not use emulation.

### BRIEF SUMMARY OF THE INVENTION

According to one aspect of the present invention, there can be provided a circuit verification apparatus including: a measurement point extracting unit configured to read a circuit description written in a hardware description language and measurement object information including information about a plurality of measurement objects, extract a plurality of measurement points for code coverage measurement from the circuit description on the basis of the measurement object information, and generate a database including only predetermined measurement points among the plurality of extracted measurement points; an assertion converting unit configured to convert each of the predetermined measurement points to a corresponding assertion description; and a measurement result generating unit configured to receive the database and an assertion result obtained by performing measurement on the basis of the assertion description, and generate a result of the code coverage measurement.

### BRIEF DESCRIPTION OF THE DRAWINGS

FIG. 1 is a block diagram showing a configuration of an information processing apparatus according to an embodiment;

FIG. 2 is a block diagram showing a configuration of a circuit verification apparatus according to the present embodiment;

FIG. 3 is a diagram illustrating an exemplary DUT circuit description and measurement points extracted;

FIG. 4 is a diagram illustrating an exemplary data structure of a measurement point;

FIG. 5 is a diagram illustrating an exemplary database built from the DUT circuit description shown in FIG. 3;

FIG. 6 is a diagram illustrating the exemplary database in which measurement points are rearranged;

FIG. 7 is a diagram illustrating the exemplary database to which assertion labels and coverage results are added;

FIG. 8 is a flowchart showing an exemplary process flow for assertion conversion;

FIG. 9 is a diagram illustrating exemplary assertion descriptions generated for the measurement point data shown in FIG. 6;

FIG. 10 is a diagram illustrating examples of compression in a Toggle;

FIG. 11 is a diagram illustrating examples of compression in a Branch and a Condition;

FIG. 12 is a diagram illustrating examples of compression of a Branch from a Toggle;

FIG. 13 is a diagram illustrating examples of compression of a Toggle or Branch from an FSM Transition;

FIG. 14 is a diagram illustrating an exemplary database compressed by an assertion compressing section;

FIG. 15 is a diagram illustrating an example in which a disabling mechanism is added in an SVA assertion language;

FIG. 16 is a diagram illustrating an exemplary database in which Cover/Not Cover data for each assertion label is stored; and

FIG. 17 is a diagram illustrating an exemplary code coverage result.

### DETAILED DESCRIPTION OF THE EMBODIMENTS OF THE INVENTION

Embodiments of the present invention will be described in detail with reference to the accompanying drawings.

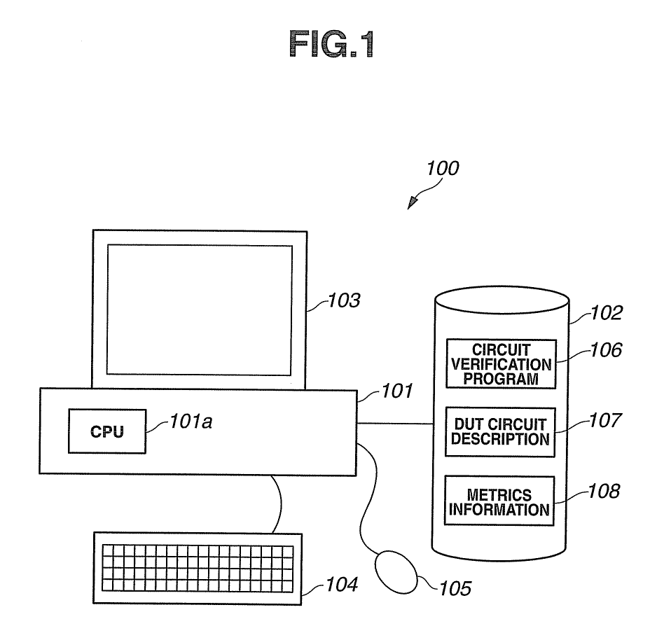

A configuration of an information processing apparatus relating to an embodiment will be described first with reference to FIG. 1. FIG. 1 is a block diagram showing a configuration of an information processing apparatus relating to the present embodiment. As shown in FIG. 1, the information processing apparatus 100, which may be a personal computer, includes a system unit 101, a storage device 102, a display device 103, a keyboard 104, and a mouse 105. The system unit 101 includes a central processing unit (hereinafter abbreviated as CPU) 101a.

The storage device 102 stores a circuit verification program 106, a DUT circuit description 107, and metrics information 108. By executing the circuit verification program 106 on the CPU 101a, a circuit verification apparatus, which will be described later, is implemented. When the circuit verification program 106 is executed on the CPU 101a, the keyboard 104 and the mouse 105 are operated to specify the DUT circuit description 107 and the metrics information 108, thereby code coverage measurement, which will be described later, can be performed.

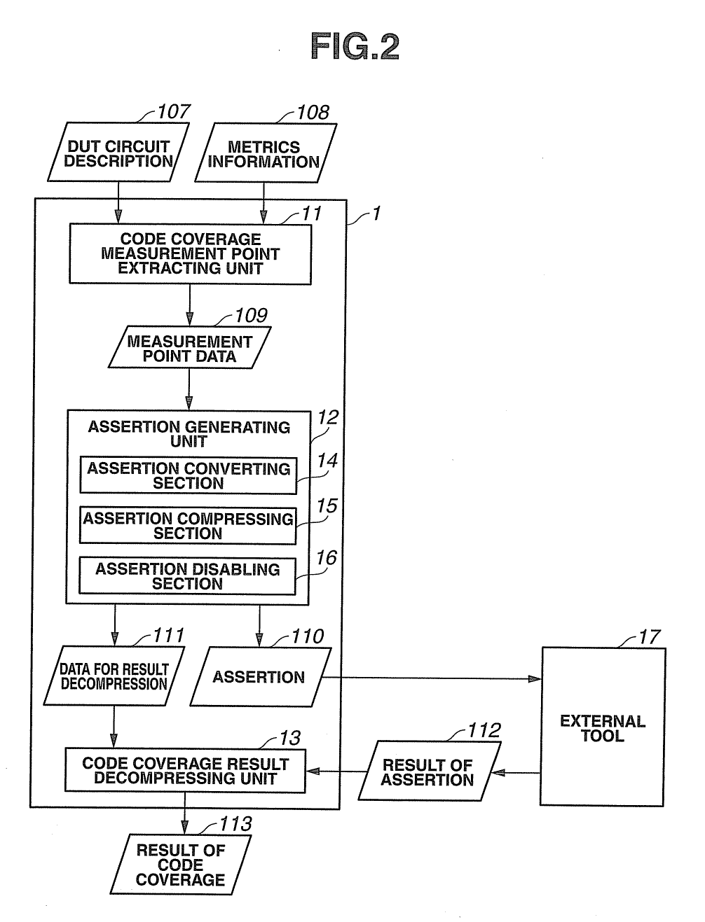

FIG. 2 is a block diagram showing a configuration of a circuit verification apparatus according to the present embodiment. As shown in FIG. 2, the circuit verification apparatus 1 includes a code coverage measurement point extracting unit 11, an assertion generating unit 12, and a code coverage result decompressing unit 13.

The assertion generating unit 12 includes an assertion converting section 14, an assertion compressing section 15, and an assertion disabling section 16.

An external tool 17 implemented by an emulator or a simulator is provided outside the circuit verification apparatus 1. The external tool 17 may include elements such as a property checker, a debugger, and a semiformal tool.

A DUT circuit description 107 to be subjected to testing and code coverage measurement and metrics information 108 which is a measure of evaluation of code coverage are input into the code coverage measurement point extracting unit 11. The code coverage measurement point extracting unit 11 extracts code coverage measurement points of a metrics specified in metrics information 108 from the DUT circuit description 107 and builds a database based on the extracted code coverage measurement points. The code coverage measurement point extracting unit 11 rearranges the database built, or organizes the code coverage measurement points here, and outputs the rearranged database to the assertion generating unit 12 as measurement point data 109.

The assertion converting section 14 of the assertion generating unit 12 converts code coverage measurement points in the measurement point data 109 to an assertion language, thereby generating assertions 110. The assertion language is one of description languages for LSI function verification. The assertion converting section 14 adds assertion result and assertion label information, which will be described later, to the database and outputs the database to the code coverage result decompressing unit 13 as data for result decompression 111.

The assertion compressing section 15 of the assertion generating unit 12 determines whether a code coverage measurement point in measurement point data 109 is compressible and, if compressible, performs compression, which will be described later.

The assertion disabling section 16 of the assertion generating unit 12 selectively adds a mechanism for disabling measurement when measurement has been performed once.

The assertion generating unit 12 outputs an assertion 110 generated by the assertion converting section 14 to the external tool 17. The assertion generating unit 12 also outputs the measurement point data 109 changed by the assertion converting section 14 and the assertion compressing section 15 to the code coverage result decompressing unit 13 as data for result decompression 111.

The external tool 17 receives the assertion 110, performs code coverage measurement, and outputs an assertion result 112 to the code coverage result decompressing unit 13.

The code coverage result decompressing unit 13 generates a final code coverage result 113, which is a result of the code coverage measurement, on the basis of the data for result decompression 111 generated by the assertion generating unit 12 and the assertion result 112 obtained by the external tool 17. The code coverage result decompressing unit 13 thus forms a measurement result generating unit which generates a result of code coverage measurement.

Metrics are evaluation measures to be subjected to code coverage measurement. There are six metrics: Statement, Branch, Condition, Toggle, FSM (Fine State Machine) State, and FSM Transition.

“Statement” is an evaluation measure indicating whether each line of a DUT circuit description 107 has been covered, that is, executed. “Branch” is an evaluation measure indicating whether a conditional branch, for example a combination of True and False of an if-statement has been executed. “Condition” is an evaluation measure indicating whether a combination of sub-conditions, for example a combination of True and False of a condition element separated by “&&”, “&”, “∥”, or “|” in an if-statement, has been executed. “Toggle” is an evaluation measure indicating whether a toggle of each signal bit has been executed. The toggle of each signal bit is a transition from 0 to 1 (rise) or a transition from 1 to 0 (fall). “FSM State” is an evaluation measure indicating whether a state of FSM has been reached. “FSM Transition” is an evaluation measure indicating whether a transition between states of FSM has been executed.

The metrics information 108 includes information on any of these metrics that is to be subjected to code coverage measurement. For example, if a user wants to subject only “Toggle” to code coverage measurement, the user writes the metrics relating to Toggle in the metrics information 108. If the user wants to subject all of the six metrics described above to code coverage measurement, the user writes all of the six metrics in the metrics information 108. The code coverage measurement point extracting unit 11 can extract measurement points specified in the metrics information 108 from a DUT circuit description 107.

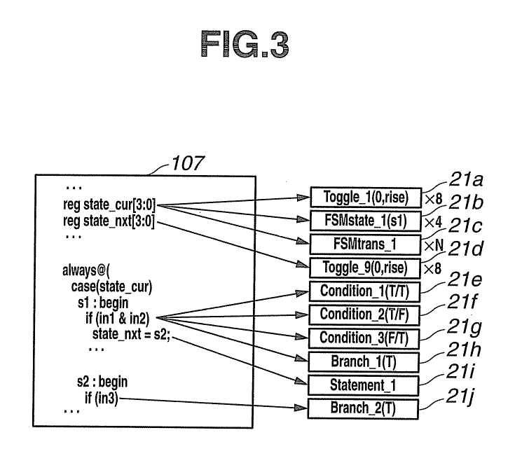

FIG. 3 is a diagram illustrating an exemplary DUT circuit description and measurement points extracted. The exemplary measurement points in FIG. 3 have been extracted based on all of the metrics described above.

The DUT circuit description 107 shown in FIG. 3 is a part of a circuit description written in a Verilog language, which is one of hardware description languages.

The code coverage measurement point extracting unit 11 extracts measurement points 21a, 21b and 21c from a DUT circuit description, “reg state_cur[3:0]”. Measurement point 21a is a measurement point relating to a toggle. While not shown in FIG. 3, eight measurement points relating to toggles are extracted from the DUT circuit description “reg state_cur[3:0]” because a rise and a fall need to be measured for each of four bits.

Similarly, the code coverage measurement point extracting unit 11 extracts a measurement point 21d from a DUT circuit description, “reg state_nxt[3:0]”, measurement points 21e through 21h from a DUT circuit description, “if(in1 & in2)”, a measurement point 21i from a DUT circuit description, “state_nxt=s2”, and a measurement point 21j from a DUT circuit description, “if(in3)”.

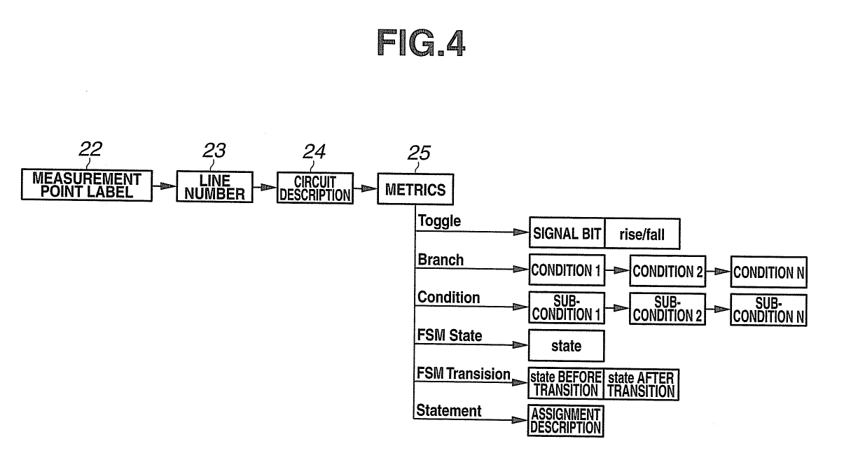

A data structure of measurement points 21a through 21j extracted by the code coverage measurement point extracting unit 11 will be described below. FIG. 4 is a diagram illustrating an exemplary data structure of a measurement point. Each of measurement points 21a through 21j has information on a “measurement point label” 22, a “line number” 23, a “circuit description” 24, and “metrics” 25.

The “Measurement point label” 22 contains a name uniquely assigned to each measurement point 21a through 21j. The “Line number” 23 contains a line number of each measurement point 21a through 21j in the DUT circuit description 107. The “Circuit description” 24 contains a description of an object under test of each measurement point 21a through 21j. The “Metrics” 25 contains one of the six metrics described above. The “Metrics” 25 includes the following information according to the metrics to be measured.

If the “Metrics” 25 contains “Toggle”, the metrics includes information on a signal bit and a rise or a fall. If the “Metrics” 25 contains “Branch”, the metrics includes information on a combination of True and False of conditions. For True, the “condition description” is maintained and for False, “! (condition description)” is contained. If the “Metrics” 25 contains “Condition”, the metrics includes information on a combination of True and False of sub-conditions. For True, the “condition description” is maintained. For False, “! (condition description)” is contained. If the “Metrics” 25 contains “FSM State”, the metrics includes information on a state. If the “Metrics” 25 contains “FSM Transition”, the metrics includes information on states before and after a state transition. If the “Metrics” 25 contains “Statement”, the metrics includes information on an assignment description which is equivalent to the “Circuit description” 24.

### (Operation of the Code Coverage Measurement Point Extracting Unit 11)

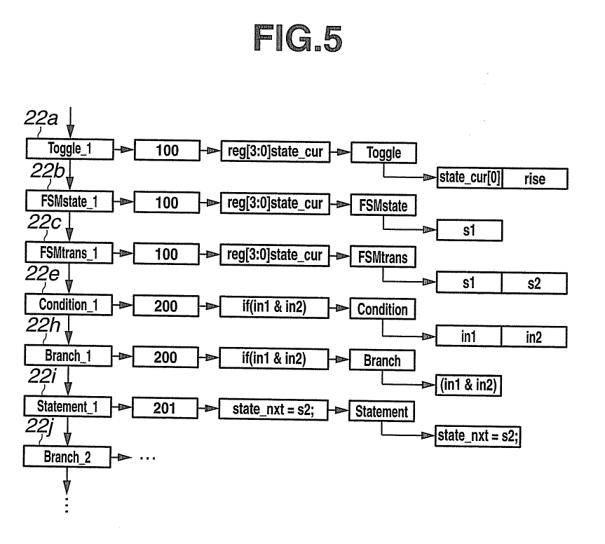

FIG. 5 is a diagram illustrating an exemplary database built from the DUT circuit description in FIG. 3. Duplicative metrics measurement points are omitted from FIG. 5. The database shown in FIG. 5 is built from measurement points 21a, 21b, 21c, 21e, 21h, and 21i.

The code coverage measurement point extracting unit 11 builds a database from the extracted measurement points 21a, 21b, 21c, 21e, 21h, and 21i. Measurement point labels 22a, 22b, 22c, 22e, 22h, and 22i are associated with the measurement points 21a, 21b, 21c, 21e, 21h, and 21i, respectively.

Information such as line numbers, circuit descriptions, and metrics are associated with the measurement point labels 22a, 22b, 22c, 22e, 22h, and 22i. That is, the measurement points 21a, 21b, 21c, 21e, 21h, and 21i each have the data structure shown in FIG. 4.

The code coverage measurement point extracting unit 11 links the measurement points 21a, 21b, 21c, 21e, 21h, and 21i in the order they have been found and builds a database having a list structure as shown in FIG. 5.

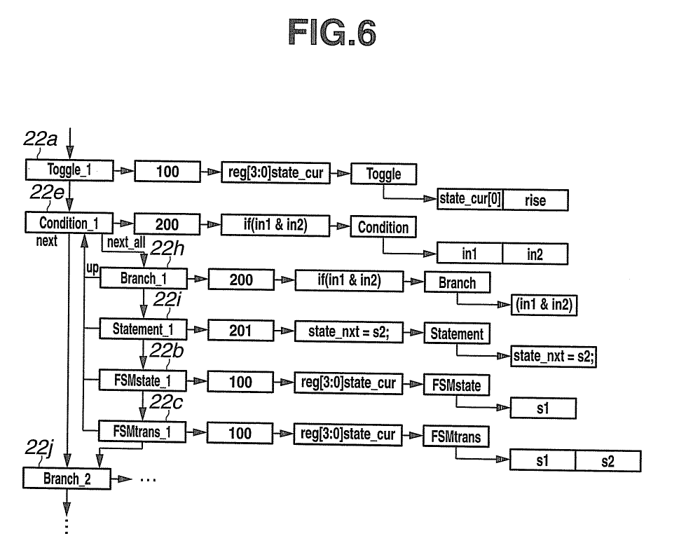

Then the code coverage measurement point extracting unit 11 rearranges the measurement points 21a, 21b, 21c, 21e, 21h, and 21i, in other words, rearranges links in the list structure. FIG. 6 is a diagram illustrating an exemplary database resulting from rearrangement of measurement points.

A circuit description is represented by a signal declaration section and a signal relationship section representing a relationship between signals. The signal relationship section includes a conditional statement and an assignment statement that is executed when the condition is true. Accordingly, only the conditional statement is measured in the signal relationship section. The assignment statement does not need to be measured because the assignment statement matches “Cover” of true/false (Branch or Condition) of the conditional statement. Since “Statement” can be measured from the execution of the assignment statement and FSM State and FSM Transition can be measured from the assignment statements, these metrics do not need to be measured. That is, metrics to be measured are Toggle, Branch, and Condition.

In the database shown in FIG. 6, the metrics to be measured are reduced to Toggle, Branch, and Condition. A “next_all” pointer points to a next measurement point that is the same as the one in the database before the rearrangement. An “up” pointer points to a measurement point that shares a coverage result. A “next” pointer links measurement points that do not have an “up” pointer, here, measurement points 21a and 21e, and measurement points 21e and 21j.

The database in which measurement points have been thus rearranged is output to the assertion generating unit 12 as measurement point data 109.

The assertion converting section 14 of the assertion generating unit 12 scans the measurement point data 109 by following the next pointers to generate assertions 110 according to measurement description. In so doing, the assertion converting section 14 assigns assertion labels to the assertions 110 and adds the assigned assertion labels to the database. The assertion converting section 14 also adds coverage result areas for storing results of code coverage to the database.

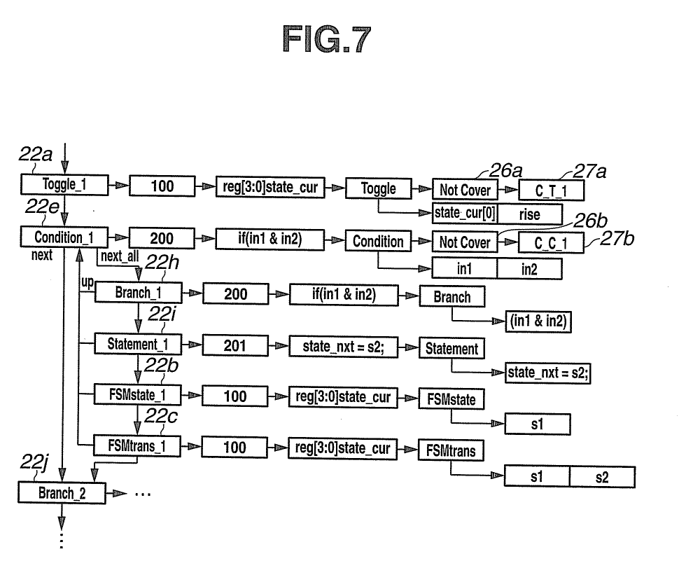

FIG. 7 is a diagram illustrating an exemplary database including added assertion labels and coverage results. As shown in FIG. 7, a coverage result 26a has been added to the measurement point 21a and a coverage result 26b has been added to the measurement point 21e. The coverage results 26a and 26b contain an initial value, “Not Cover”, which indicates that measurement has not yet been performed. Each of the coverage results 26a and 26b is a coverage result storage area storing data indicating whether measurement has been performed or not. That is, the assertion converting section 14 adds a coverage result storage area to the database for each of the measurement points 22a and 22e. In addition, an assertion label 27a, “C_T_1”, is assigned to the measurement point 21a and an assertion label 27b, “C_C_1”, is assigned to the measurement point 21e.

The coverage results 26a and 26b are the results of code coverage measured subsequently by the external tool 17. Assertion labels 27a and 27b are unique assertion labels assigned to measurement points, here the measurement points 21a and 21e, linked by a next pointer.

The database having the coverage results 26a and 26b and the assertion labels 27a and 27b thus added is output to the code coverage result decompressing unit 13 as data for result decompression 111.

### (Operation of the Assertion Converting Section 14)

Assertions are generated for any of the measurement metrics, Toggle, Branch, and Condition. Assertion conversion methods for Toggle, Branch, and Condition will be described with respect to an example in which an SVA (System Verilog Assertion) assertion language is used. Assertions generated are not limited to those in the SVA assertion language. Assertions may be generated in any other assertion language.

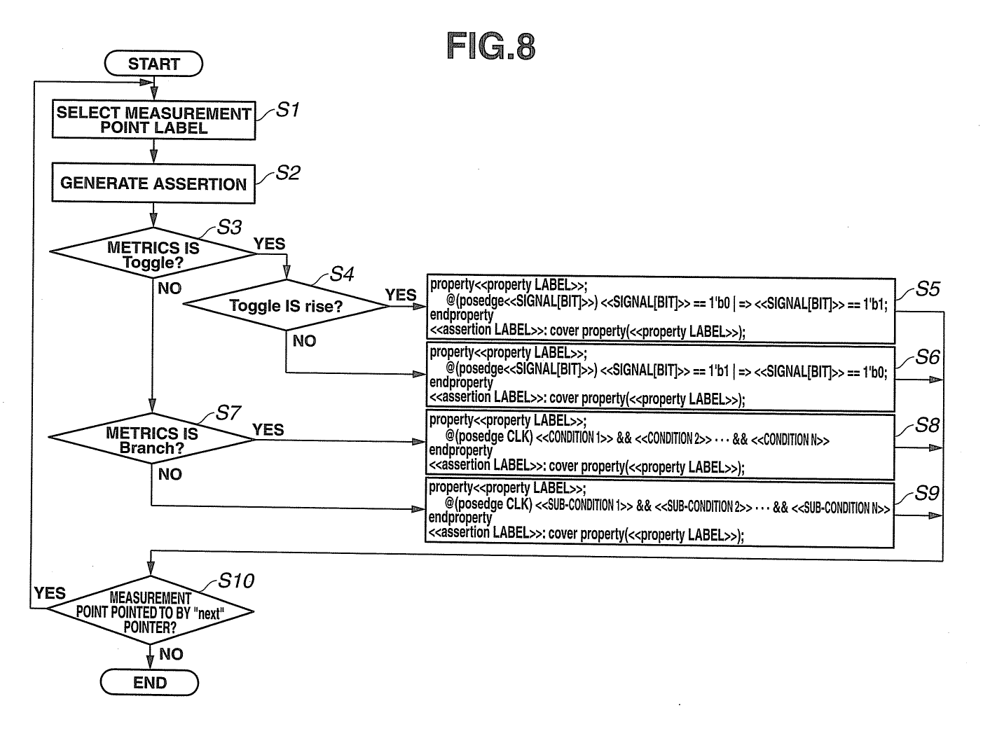

An assertion conversion process in the assertion converting section 14 will be described. FIG. 8 is a flowchart illustrating an exemplary process flow of assertion conversion.

The assertion conversion process for generating an assertion 110 is started upon input of measurement point data 109 into the assertion converting section 14. First, the assertion converting section 14 selects a measurement point label (step S1). The assertion converting section 14 then generates an assertion from the selected measurement point label (step S2). The assertion converting section 14 determines whether the metrics in the selected measurement point label is Toggle (step S3). If the metrics is Toggle, that is, the determination is YES, the assertion converting section 14 determines whether the Toggle is a rise (step S4). If the Toggle is a rise, that is, the determination is YES, the assertion converting section 14 converts the assertion to an assertion shown in S5 and then proceeds to step S10. Otherwise, that is, if the determination is NO, the assertion converting section 14 converts the assertion to an assertion shown in S6 and then proceeds to step S10.

On the other hand, if the metrics is not Toggle, that is, the determination at step S3 is NO, the assertion converting section 14 determines whether the metrics in the selected measurement point label is Branch (step S7). If the metrics is Branch, that is, the determination is YES, the assertion converting section 14 converts the assertion to an assertion shown in step S8 and then proceeds to step S10. If the metrics is not Branch, that is, the determination is NO, the assertion converting section 14 converts the assertion to an assertion shown in step S9 and then proceeds to step S10. Since the metrics for which an assertion is to be generated is Toggle, Branch or Condition as stated above, the metrics is Condition if the metrics is neither Toggle nor Branch. Finally, the assertion converting section 14 determines whether there is measurement point, that is, a measurement point label, that follows the “next” pointer (step S10). If there is a measurement point, that is, the determination is YES, the assertion converting section 14 returns to step S1, selects the measurement point label that follows the “next” pointer, and repeats the same process. On the other hand, if there is not a measurement point, that is, the determination is NO, the process will end.

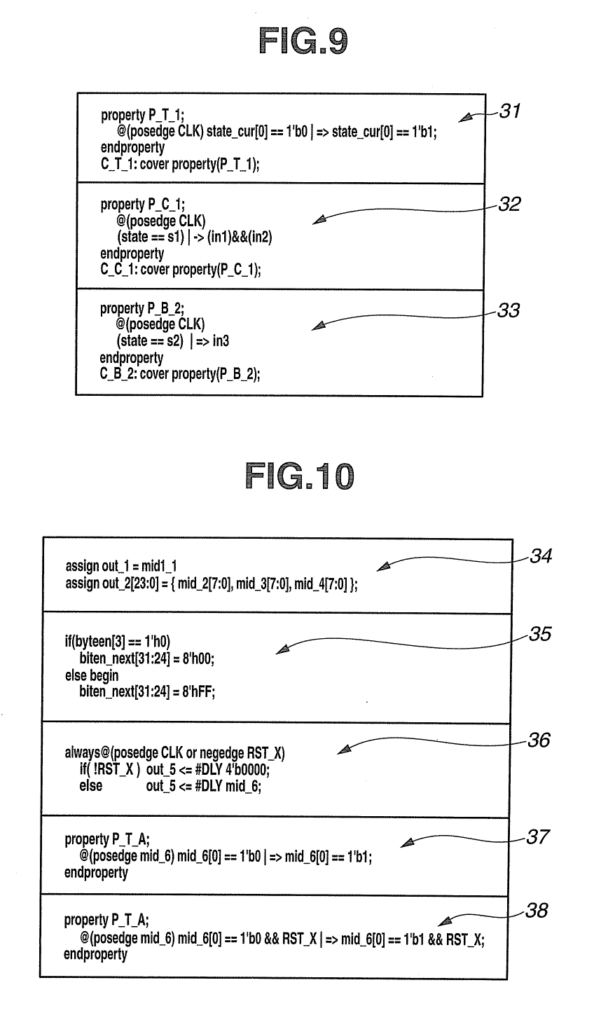

FIG. 9 is a diagram illustrating exemplary assertion descriptions generated for the measurement point data in FIG. 6.

The assertion description 31 is an exemplary assertion description generated for the measurement point 21a. The assertion description 32 is an exemplary assertion description generated for the measurement point 21e. The assertion description 33 is an exemplary assertion description generated for the measurement point 21j.

Since the metrics of the measurement point 21a is a toggle relating to a rise, the assertion description 31 is generated based on the assertion shown in step S5. The metrics of the measurement point 21e is Condition and therefore the assertion description 32 is generated based on the assertion shown in step S9. Similarly, the metrics of the measurement point 21j is Branch and therefore the assertion description 33 is generated based on the assertion shown in step S8. The assertion descriptions 31 through 33 thus generated are output to the external tool 17 as assertions 110.

### (Operation of the Assertion Compressing Section 15)

The database shown in FIG. 7 is input into the assertion compressing section 15. The assertion compressing section 15 determines whether the measurement points 21a, 21e, and 21j can be compressed, that is, whether other measurement points can be substituted for the measurement points 21a, 21e, and 21j and the measurement points 21a, 21e, and 21j themselves do not need to be measured. If the assertion compressing section 15 determines that the measurement points can be compressed, the assertion compressing section 15 changes the links of the measurement points that do not need to be measured to the measurement points that can be substituted for those measurement points. The purpose of the compression is to reduce the measurement points and overhead in time and space associated with the subsequent code coverage measurement in the external tool 17.

Compression methods are broadly classified into four types: compression within a Toggle, compression within a Branch and a Condition, compression from a Toggle to a Branch, and compression from an FSM Transition to a Toggle or Branch.

FIG. 10 is a diagram illustrating an example of compression within a Toggle.

The circuit description 34 is an exemplary circuit description for a link that does not include an operation in continuous assignment such as “assign (wire)”. In the circuit description 34, the toggle of “out_1” is identical to the toggle of “mid_1” and therefore can be compressed. Also, the toggle of each bit of “out_2[23:0]” is identical to the toggle of each bit of “mid_2[7:0]”, “mid_3[7:0], and “mid_4[7:0] and therefore can be compressed.

The circuit description 35 is an exemplary circuit description for a byte enable signal or the like in which the toggle of an output signal is determined from measurement of a toggle of a condition. In the circuit description 35, the toggle of “Biten_next[31:24]” is identical to the toggle of “byteen[3]” and therefore can be compressed.

Like the circuit description 34, circuit description 36 can be compressed by crossing the toggle of a target variable with a condition of another signal (mainly a reset signal). In the circuit description 36, if RST_X=1′b1, the toggle is equivalent to the toggle of “mid_6”. The condition “RST_X=1′b1” is added to the original assertion description for the compression. This operation will be referred to as “cross coveraging”.

The assertion description 37 is an example of a compression target assertion before cross coveraging. The assertion description 38 is an example of the compression target assertion after cross coveraging. A description “&&RST_X” is added to the assertion description 38 by cross coveraging. Cross coveraging makes coverage criteria stricter and therefore the coverage of both compression source and target can decrease to a level below actual coverage. However, a reset is infrequently input and therefore the impact of the cross coveraging on the coverage is small. In addition, depending on the circumstances, greater importance is placed on toggles in the absence of a reset input and therefore no problem will arise. Enable and disable of compression by cross coveraging can be optionally controlled.

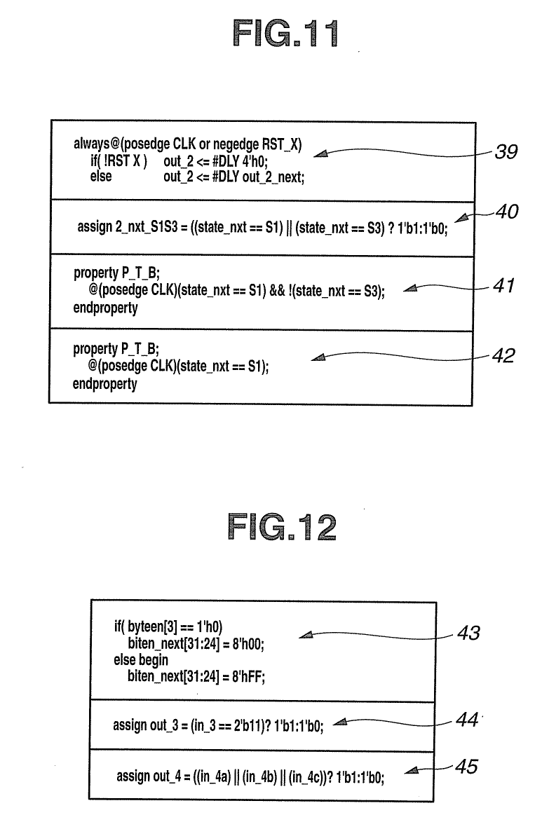

FIG. 11 is a diagram illustrating an example of compression within a Branch and Condition.

The circuit description 39 can be compressed because a Branch that depends on whether there is a reset or not can be shared between other output signals.

In the circuit description 40, for a condition using logical OR (∥) with the same condition variables, if one of the values is True, the other is necessarily False. The assertion description 41 is an example of a compression target assertion before cross coveraging of conditions, S1==True, S3==False. The assertion description 42 is an example of the compression target assertion after cross coveraging. Since if (state_nxt=S1), always “! (state_next==S3)” will result, “! (state_nxt==S3)” is deleted from the assertion description 41 by cross coveraging. Since (state_nxt==S1) is the coverage of FSM State, (state_nxt==S1) can be compressed to the measurement point of a Branch or Condition to which it belongs.

FIG. 12 is a diagram illustrating an example of compression from a Toggle to a Branch.

The circuit description 43 can be compressed because the Branch is determined from the measurement of the toggle of a condition. That is, the Branch of if/else can be compressed because the Branch is covered by the toggle of “byteen[3]”.

In circuit description 44, both True and False of a Branch is covered by the toggle of an output. That is, True and False Branches of (in_3==2′b11) can be compressed because both are covered by a rise or a fall of “out_3”.

In the circuit description 45, a Branch is determined from the toggle of an output, that is, a condition without a variation of True/False can be compressed. That is, Conditions the Branch of which are False, “in_4a:False”, “in_4b:False” and “in_4c:False” can be compressed by a rise or a fall of “Out_4”.

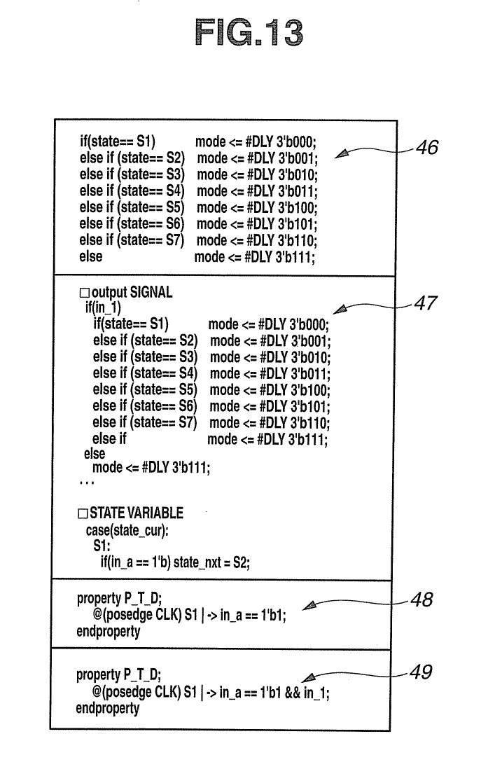

FIG. 13 is a diagram illustrating an example of compression of a Toggle or Branch from FSM Transition.

The circuit description 46 is a so-called Moore FSM in which an output is determined by the state of FSM. In the circuit description 46, the toggle of an output signal or a state variable can be compressed from the Cover of FSM Transition already compressed to a Branch or Condition. For example, if transition from S2 to S3 occurs, a fall of “mode[0]” and a rise of “mode[1]” are covered. Since generally fall/rise of each bit is covered by multiple FSM Transitions, an “up” pointer is linked to multiple compression targets.

The circuit description 47 is a so-called Mealy FSM in which an output is determined by the state of FMS and an input signal. In the circuit description 47, the toggle of an output signal can be compressed from the Cover of cross coverage of FSM Transition already compressed to a Branch or Condition and an input signal. For example, if “in_1” is true and transition from S1 and S2 occurs, a fall of “mode[0]” and a rise of “mode[1]” need to be cross-coveraged. Enable and disable of compression by cross coveraging can also be optionally controlled. The assertion description 48 is an example of a compression target assertion before cross-coveraging. The assertion description 49 is an example of the compression target assertion after cross-coveraging. Since a fall/rise of a bit in general can be covered by multiple FSM transitions, multiple compression targets are cross-coveraged and an “up” pointer is linked to the compression targets.

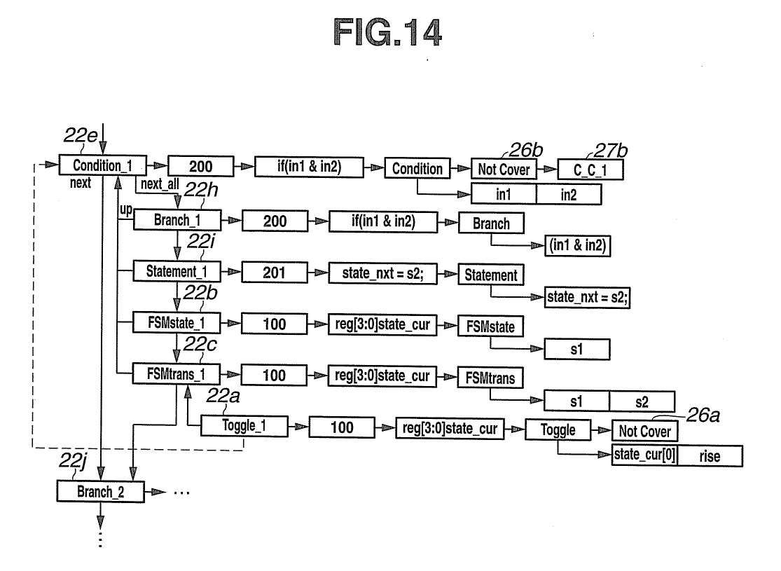

FIG. 14 is a diagram illustrating an exemplary database compressed by an assertion compressing section. The database shown in FIG. 14 results from applying the compression described with respect to the circuit description 46 in FIG. 13 to the database in FIG. 7. That is, a toggle is compressed from Cover of FSM Transition. The need for measuring the measurement point 21a has been eliminated by the compression. The assertion compressing section 15 changes the links of pointers in conjunction with the compression. As a result, the measurement point 21a which was linked to the measurement point 21e before the compression is now linked to the measurement point 21c by an “up” pointer after the compression.

The assertion converting section 14 can generate assertions 110 having a reduced number of measurement points by applying assertion conversion to the database compressed by the assertion compressing section 15. The assertion generating unit 12 outputs the assertions 110 with a reduced number of measurement points to the external tool 17. Consequently, the overhead in time and space associated with code coverage measurement in the external tool 17 can be reduced.

If compression has been applied to assertions, the assertion generating unit 12 also outputs the database shown in FIG. 14 compressed by the assertion compressing section 15 to the code coverage result decompressing unit 13 as data for result decompression 111.

### (Operation of the Assertion Disabling Section 16)

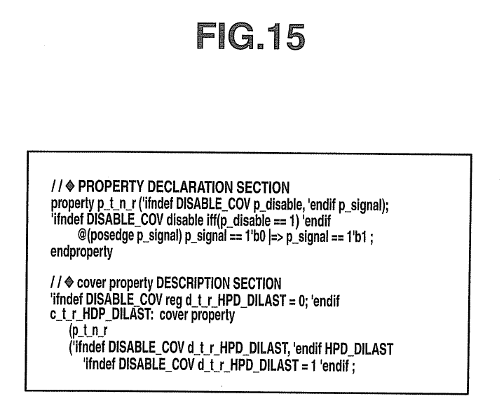

The assertion disabling section 16 adds a disabling mechanism to an assertion 110 generated by the assertion converting section 14. The disabling mechanism disables measurement when code coverage measurement has been performed. FIG. 15 is a diagram illustrating an example in which the disabling mechanism in the SVA assertion language is added.

Code coverage measurement has to check whether measurement has been performed one or more times but in some cases does not have to check how many times measurement has been performed. By adding a disabling mechanism that disables measurement once it has been determined that measurement has been performed during code coverage measurement performed in simulation, overhead in time in the code coverage measurement can be reduced.

On the other hand, when code coverage measurement is performed in emulation, overhead in space during mapping of assertions 110 can be a problem rather than overhead in time. Therefore, the disabling mechanism is not added when code coverage measurement is performed in emulation, thereby avoiding overhead in space which would be caused by addition of the disabling mechanism.

To that end, conditional compilation is used to generate assertions so that the disabling mechanism can be selectively enabled when the assertions are used. That is, the disabling mechanism is added (turned on) when simulation is performed and not added (turned off) when emulation is performed. The disabling mechanism may be added to all measurement points or addition of the disabling mechanism may be made user-selectable for each measurement point.

An example is shown below in which the disabling mechanism is added in the SVA assertion language. The disabling mechanism is turned on at run-time by default. The disabling mechanism can be turned off by adding a macro, “DISABLE_COV”.

In the property declaration section in FIG. 15, a property is declared by the name “p_t_n_r”. When “DISABLE_COV” is not defined, the assertion is not evaluated if a cover flag, “p_disable”, is 1.

In the Cover property description section, an internal variable, “d_t_r_HPD_DILAST”, is defined as a cover flag when “DISABLE_COV” is not defined. A cover property, “c_t_r_HPD_DILAST”, is defined for the property “p_t_n_r”. When “DISABLE_COV” is not defined, an argument, “d_t_r_HPD_DILAST”, is given. When the property has been covered, that is, measurement has been performed, the Cover flag “d_t_r_HPD_DILAST” is set to 1.

By selectively adding the disabling mechanism to assertions 110 by the assertion disabling section 16 in this way, overhead in time during code coverage measurement can be reduced.

The assertion generating unit 12 thus generates assertions 110 for code coverage measurement. The generated assertions 110 are output to the external tool 17. The assertions 110 can be input into a simulator as well as an emulator.

The external tool 17, which may be a simulator or an emulator, receives the assertions 110, performs code coverage measurement, and outputs assertion results 112 obtained from the measurement to the code coverage result decompressing unit 13.

As stated earlier, the external tool 17 may include a property checker, a debugger, and the like. By inputting assertions 110 in a property checker, dead conditions that will not be executed for any input can be identified and the time for analysis required where code coverage measurement has not been performed can be reduced. By inputting assertions 110 in a waveform viewer of a debugger, the timing at which Cover, that is, code coverage measurement has been performed can be identified and debugging time can be reduced.

### (Operation of the Code Coverage Result Decompressing Unit 13)

The code coverage result decompressing unit 13 receives data for result decompression 111 generated by the assertion generating unit 12 and assertion results 112 generated by the external tool 17 and generates a final code coverage result 113.

First, the code coverage result decompressing unit 13 confirms the results (Cover/Not Cover) of code coverage measurement of all measurement points from the assertion results 112 as follows. The code coverage result decompressing unit 13 scans the assertion results 112 generated by an assertion report function of the external tool 17. The code coverage result decompressing unit 13 stores Cover/Not Cover data for each assertion label obtained by scanning the assertion results 112 in the database.

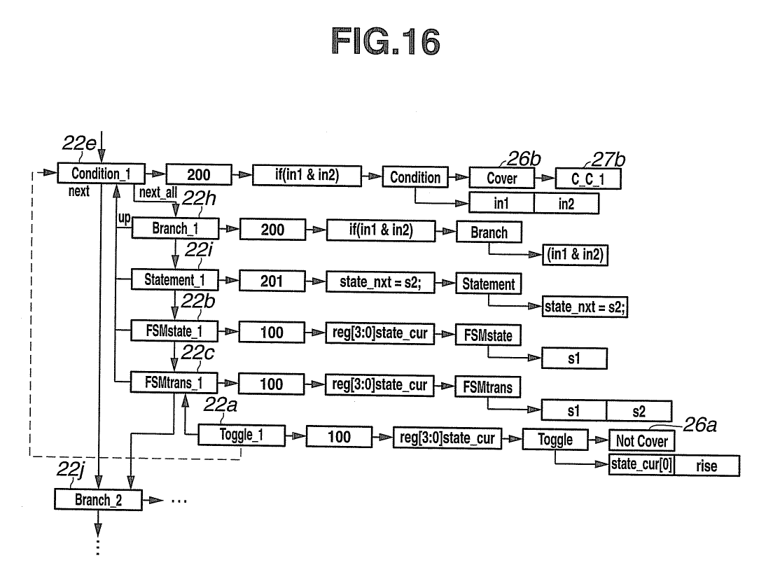

FIG. 16 is a diagram illustrating an exemplary database in which Cover/Not Cover data for each assertion label is stored. When the code coverage results decompressing unit 13 determines as a result of scanning of an assertion result 112 that code coverage measurement of the measurement point 21e has been performed, the code coverage result decompressing unit 13 stores “Cover” in the coverage result 26b in the database.

Then, the code coverage result decompressing unit 13 follows a “next_all” pointer in the database. The code coverage result decompressing unit 13 follows until all “up” pointers of the measurement points do not point other point, in other words, until the “up” pointers point Null. If at least one of the measurement points along the path has Cover, the code coverage result decompressing unit 13 adds Cover to the database. If at least one of the measurement points does not have Cover, the code coverage result decompressing unit 13 adds Not cover to the database. The code coverage result decompressing unit 13 outputs the database as a final code coverage result 113.

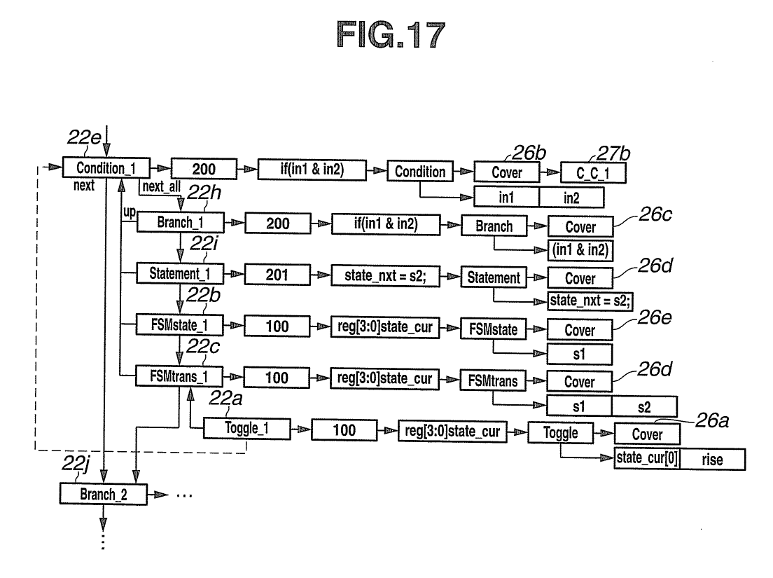

FIG. 17 is a diagram illustrating an exemplary result of code coverage. As shown in FIG. 17, coverage results 26c, 26d, 26e, and 26d are added to measurement points 21h, 21i, 22b, and 22c, respectively. Because the measurement point 21e has Cover, the coverage results 26c, 26d, 26e, and 26d of all measurement points 21h, 21i, 21b, and 21c linked to the measurement point 21e contain Cover. Because the measurement point 21c has Cover, the coverage result 26a of the measurement point 21a linked to the measurement point 21c contains Cover. The database having the coverage results 26a, 26c, 26d, 26e, and 26d added in this way is output from the code coverage result decompressing unit 13 as the final code coverage result 113.

By the processing performed by the code coverage result decompressing unit 13, the original coverage result can be reconstructed from the minimum number of measurement points without losing code coverage information. In the example in FIG. 17, coverage results for the measurement points 21a, 21b, 21c, 21h, and 21i can be obtained based on the coverage result 26b for the measurement point 21e.

As has been described above, the circuit verification apparatus 1 extracts measurement points from a DUT circuit description 107 on the basis of metrics specified in metrics information 108 and converts the extracted measurement points to assertions. Consequently, code coverage measurement can be performed using an emulator.

Therefore, the circuit verification apparatus according to the present embodiment is capable of performing code coverage measurement in emulation.

The “unit” and “section” as used herein are conceptual equivalents to functions of embodiments and are not necessarily in one-to-one correspondence to specific hardware components or software routines. Accordingly, the present embodiments have been described with respect to imaginary circuit blocks (units or sections) having the functions of the present embodiments. The steps of any of the processes in the flowcharts herein may be performed in other order, or some of the steps may be performed at a time, or the steps may be performed in different orders in different runs unless the order is inconsistent with the nature of the process.

All or part of a program that executes the operation described above is recorded or stored on a portable medium such as a flexible disk or CD-ROM, or a storage medium such as a hard disk. The program code is read by a computer and all or part of operation is performed by the computer. Alternatively, all or part of the program can be distributed or provided through a communication network. A user can download and install the program on a computer through the communication network or install the program on a computer from the recording medium to readily implement the circuit verification apparatus of the present invention.

The present invention is not limited to the embodiments described above. Various changes and modification can be made to the embodiments without departing from the spirit of the present invention.

What is claimed is:

1. A circuit verification apparatus comprising:
a measurement point extracting unit configured to read a circuit description written in a hardware description language and measurement object information including information about a plurality of measurement objects, extract a plurality of measurement points for code coverage measurement from the circuit description on the basis of the measurement object information, and generate a database including only predetermined measurement points among the plurality of extracted measurement points;
an assertion converting unit configured to convert each of the predetermined measurement points to a corresponding assertion description; and
a measurement result generating unit configured to receive the database and an assertion result obtained by performing measurement on the basis of the assertion description, and generate a result of the code coverage measurement.

2. The circuit verification apparatus according to claim 1, wherein the assertion converting unit adds to the database a coverage result storage area for each of the predetermined measurement points.

3. The circuit verification apparatus according to claim 2, wherein the measurement result generating unit stores first data indicating whether the code coverage measurement has been performed or not in the coverage result storage area on the basis of the received assertion result.

4. The circuit verification apparatus according to claim 3, wherein the measurement result generating unit generates second data indicating whether the code coverage measurement of the plurality of measurement points has been performed from the first data stored in the coverage result storage area and then generates a result of the code coverage measurement.

5. The circuit verification apparatus according to claim 1, wherein:
the predetermined measurement points are measurement points relating to a combination of a signal transition, a conditional branch, and a sub-condition; and
the circuit verification apparatus further comprises an assertion compressing unit configured to determine whether any of the plurality of measurement points can be substituted for at least one of the measurement points relating to a combination of a signal transition, a conditional branch, and a sub-condition and, if any of the measurement points can be substituted for at least one of the measurement points, perform compression processing to substitute the measurement point for the at least one measurement point.

6. The circuit verification apparatus according to claim 5, wherein if the assertion compressing unit determines that any of the plurality of measurement points can be substituted for at least one of the measurement points, the assertion compressing unit changes a link of the at least one measurement point to any of the plurality of measurement points determined to be able to be substituted for the at least one measurement point.

7. The circuit verification apparatus according to claim 5, wherein the assertion converting unit generates the assertion description for a measurement point compression-processed by the assertion compressing unit.

8. The circuit verification apparatus according to claim 5, further comprising an assertion disabling unit configured to selectively add a disabling mechanism to disable the measurement to all of the measurement points relating to a combination of a signal transition, a conditional branch and a sub-condition when the measurement has been performed once for the measurement points.

9. The circuit verification apparatus according to claim 5, wherein the assertion disabling unit selectively adds the disabling mechanism to some of the measurement points relating to a combination of a signal transition, a conditional branch, and a sub-condition.

10. A circuit verification method comprising:
reading a circuit description written in a hardware description language and measurement object information including information about a plurality of measurement objects, extracting a plurality of measurement points for code coverage measurement from the circuit description on the basis of the measurement object information, and generating a database including only predetermined measurement points among the plurality of extracted measurement points;
converting each of the predetermined measurement points to a corresponding assertion description; and
receiving the database and an assertion result obtained by performing measurement on the basis of the assertion description, and generating a result of the code coverage measurement.

11. The circuit verification method according to claim 10, wherein a coverage result storage area for each of the predetermined measurement points is added to the database and first data indicating whether the code coverage measurement has been performed or not is stored in the coverage result storage area on the basis of the received assertion result.

12. The circuit verification method according to claim 11, wherein second data indicating whether the code coverage measurement of the plurality of measurement points has been performed is generated from the first data stored in the coverage result storage area and then a result of the code coverage measurement is generated.

13. The circuit verification method according to claim 10, wherein:
the predetermined measurement points are measurement points relating to a combination of a signal transition, a conditional branch, and a sub-condition; and
determination is made as to whether any of the plurality of measurement points can be substituted for at least one of the measurement points relating to a combination of a signal transition, a conditional branch, and a sub-condition and, if any of the measurement points can be substituted for at least one of the measurement points, compression processing is performed to substitute the measurement point for the at least one measurement point and a result of the code coverage measurement is generated.

14. The circuit verification method according to claim 13, wherein if it is determined that any of the plurality of measurement points can be substituted for at least one of the measurement points, a link of the at least one measurement point is changed to any of the plurality of measurement points determined to be able to be substituted for the at least one measurement point.

15. The circuit verification method according to claim 13, wherein the assertion description is generated for the compression-processed measurement point.

16. The circuit verification method according to claim 13, wherein an a disabling mechanism to disable the measurement is selectively added to all of the measurement points relating to a combination of a signal transition, a conditional branch and a sub-condition when the measurement has been performed once for the measurement points.

17. The circuit verification method according to claim 13, wherein the disabling mechanism is selectively added to some of the measurement points relating to a combination of a signal transition, a conditional branch, and a sub-condition.

18. A computer-readable recording medium on which a circuit verification program for causing a computer to perform circuit verification is recorded, comprising:
a first code section configured to read a circuit description written in a hardware description language and measurement object information including information about a plurality of measurement objects, extract a plurality of measurement points for code coverage measurement from the circuit description on the basis of the measurement object information, and generate a database including only predetermined measurement points among the plurality of extracted measurement points;
a second code section configured to convert each of the predetermined measurement points to a corresponding assertion description; and
a third code section configured to receive the database and an assertion result obtained by performing measurement on the basis of the assertion description, and generate a result of the code coverage measurement.

19. The recording medium according to claim 18, wherein:
the predetermined measurement points are measurement points relating to a combination of a signal transition, a conditional branch, and a sub-condition; and
the recording medium further comprises a fourth code section configured to determine whether any of the plurality of measurement points can be substituted for at least one of the measurement points relating to a combination of a signal transition, a conditional branch, and a sub-condition and, if any of the measurement points can be substituted for at least one of the measurement points, perform compression processing to substitute the measurement point for the at least one measurement point; and
after the compression processing is performed, the third code section generates a result of the code coverage measurement.

20. The recording medium according to claim 19, further comprising a fifth code section configured to selectively add a disabling mechanism to disable the measurement to all of the measurement points relating to a combination of a signal transition, a conditional branch and a sub-condition when the measurement has been performed once for the measurement points.
